(19) United States
(12) Patent Application Publication
(10) Pub. No.: US 2009/0285434 A1
(43) Pub. Date: Nov. 19, 2009

(54) EARHOOK AND EARBUD HEADSET

(76) Inventors: Jason Martin Williams, Sandy Hook, CT (US); David Robert Gray, Milford, CT (US); Marco Perry, Brooklyn, NY (US); Jordan B. Nollman, San Francisco, CA (US); William Webb, San Francisco, CA (US)

Correspondence Address: CANTOR COLBURN, LLP, 20 Church Street, 22nd Floor, Hartford, CT, 06103, US

(21) Appl. No.: 12/119,950

(22) Filed: May 13, 2008

(51) Int. Cl. H04R 1/10; H04R 25/00

(52) U.S. Cl. 381/375; 381/380; 381/381

(57) ABSTRACT

A headset (10) comprises an earhook (12) and an earbud (14) which are removably connected to each other so that the earbud may be removed from the earhook to enable a user to use the earbud alone. Further, the earbud (14) is connected to the earhook (12) so as to be rotatable relative to the earhook from one side thereof to the other, to thereby enable the headset (10) to be worn on either the left or right ear of the wearer, and/or to configure two such headsets (10) to be worn as a pair, one on each ear.

### BACKGROUND OF THE INVENTION

1. Field of the Invention

The present invention relates to a headset comprising an earhook and an earbud which may be detachably connected to each other so that the earbud may be worn with or without the earhook. Alternatively, or in addition, the earbud may be rotatable through the plane of the earhook a desired amount to configure the headset for a more comfortable fit or to enable the headset to be worn on either the left or the right ear.

Earbuds are small speakers that are worn in the external portion of the ear and allow the user to listen to high quality signals without the necessity of a bulky headphone. For over a decade, earbuds have gained wide spread popularity for use with small handheld listening devices, such as the Sony Walkman. More recently, earbuds have become even more popular for use with CD players, iPods, MP3 players and mobile phones. People often wear earbuds while moving, such as walking, running, exercising and driving. Earbuds may also include a microphone for use in telecommunications, such as with a mobile phone. Typically, earbuds are small and fit into the ear canal with a loose fit and thus may become dislodged during movement. Earbuds, however, have many advantages over traditional headphones that include headbands that are worn over the head. Headphones are less comfortable and less compact, and more visible.

2. Related Art

Earhooks for headsets vary in size and purpose. For example, U.S. Design Pat. No. 480,073 for “Telephone Headset Earhook” issued on Sep. 30, 2003 and discloses an earhook for a telephone headset having an open section (FIGS. 1 and 2) and lying in a flat, straight plane in end view (FIGS. 3-6). U.S. Pat. No. 7,013,018 for “Earring For A Headset” issued Mar. 14, 2006 and discloses a complete, i.e., closed, ring that can be adjusted in size and is worn on and surrounding one ear of a user for retaining a headset on the ear. U.S. Design Pat. No. 494,568 for “Bluetooth Headset” issued on Aug. 17, 2004 and discloses a bluetooth headset where the bluetooth is secured to an earhook having an open section by an open mounting ring on the stem of the earhook. These types of earhooks can result in a loose fit where the earbud and/or headset may be easily dislodged from its desired position.

### SUMMARY OF THE INVENTION

Generally, one aspect of the present invention provides an earhook for an earbud which earhook and earbud may be detachably connected to each other so as to permit use of the earbud with or without the earhook. Another aspect of the present invention provides that the earbud may be rotatable through the plane of the earhook a selected amount, including from one side of the earhook to the other, so that the user may selectively configure the headset for enhanced comfort and for wearing on either ear. The earhook may include a recessed portion so that a wire connected to the earbud is received within the recessed portion to allow the earhook and earbud to form a lower profile when the earhook is attached to the earbud.

Specifically, in accordance with the present invention there is provided a headset comprising an earbud having a speaker and a stem, and an earhook having an inlet end, the stem and the inlet end being configured to enable removable coupling of the earbud and earhook to each other.

In one aspect of the present invention, the stem has an opening at one end and the earhook has an inlet end configured to be at least partly received within the opening to effectuate the removable coupling of the earbud and earhook to each other, for example, by a snap fit.

In another aspect of the present invention, the earhook lies in a plane and the earbud is mounted on the earhook for rotation transversely through the plane in which the earhook lies, e.g., for rotation of at least about 180 degrees, from one side of the earhook to the other.

Other aspects of the present invention are disclosed in the appended drawings and the following description.

### BRIEF DESCRIPTION OF THE DRAWINGS

FIG. 1 shows a front elevation view of a headset in accordance with one embodiment of the present invention, with the earhook and the earbud attached to each other;

FIG. 2 shows a top view of the headset of FIG. 1;

FIG. 3 shows a bottom view of the headset of FIG. 1;

FIG. 4 shows a left side view of the headset of FIG. 1;

FIG. 5 shows a right side view of the headset of FIG. 1;

FIG. 6 shows a rear elevation view of the headset of FIG. 1;

FIG. 7 shows a perspective view of the headset of FIG. 1 with the earhook and the earbud detached from each other;

FIG. 8 shows a perspective view of the headset of FIG. 1 with the earhook and the earbud attached to each other;

FIG. 9 shows a front elevation view of the earhook only of FIG. 1;

FIG. 10 shows a top view of the earhook only of FIG. 1;

FIG. 11 shows a bottom view of the earhook only of FIG. 1;

FIG. 12 shows a perspective view of the earhook only of FIG. 1;

FIG. 13 shows a front view of another embodiment of an earhook in accordance with the present invention;

FIG. 14 shows a top view of the earhook of FIG. 13;

FIG. 15 shows a bottom view of the earhook of FIG. 13;

FIG. 16 shows a front view of another embodiment of an earhook in accordance with the present invention;

FIG. 17 shows a perspective view of a headset in accordance with another embodiment of the present invention including a microphone;

FIG. 18 shows a perspective view of a headset in accordance with yet another embodiment of the present invention including a control unit;

FIG. 19 shows a front view of another embodiment of an earhook in accordance with the present invention;

FIG. 20 shows an internal support in accordance with the embodiment of FIG. 19 with the outer ring shown in transparency;

FIG. 21 shows a front perspective view of another embodiment of a head set in accordance with the present invention;

FIG. 22 shows a front perspective view of the earhook in accordance with the embodiment of FIG. 21;

FIG. 23 shows a front perspective view of the earbud in accordance with the embodiment of FIG. 21;

FIG. 24 shows a front view of the earhook in accordance with the embodiment of FIG. 21;

FIG. 25 shows a left front view of the earhook in accordance with the embodiment of FIG. 21;

FIG. 26 shows a right front view of the earhook in accordance with the embodiment of FIG. 21;

FIG. 27 shows a bottom right view of the earhook in accordance with the embodiment of FIG. 21; and

FIG. 28 shows a cross sectional view of the earhook in accordance with the embodiment of FIG. 21 taken along line A-A of FIG. 24.

### DETAILED DESCRIPTION OF EMBODIMENTS OF THE INVENTION

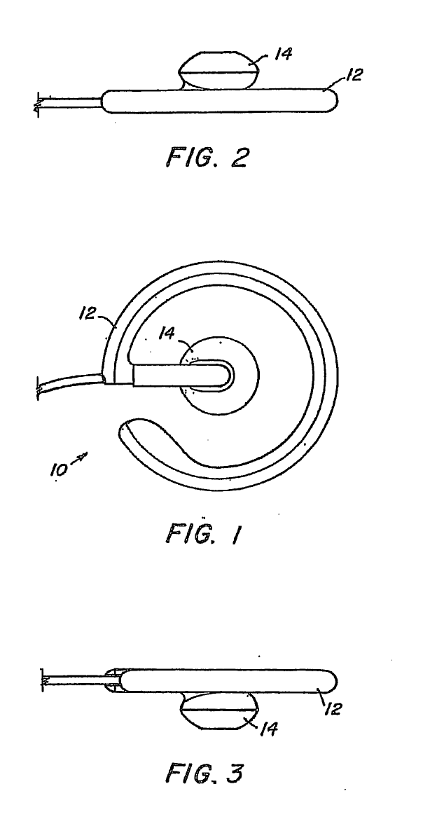

Referring to FIGS. 1-8, a headset 10 in accordance with one embodiment of the present invention is illustrated. The headset 10 comprises an earhook 12 and an earbud 14 which are detachably connected to each other as described in more detail below.

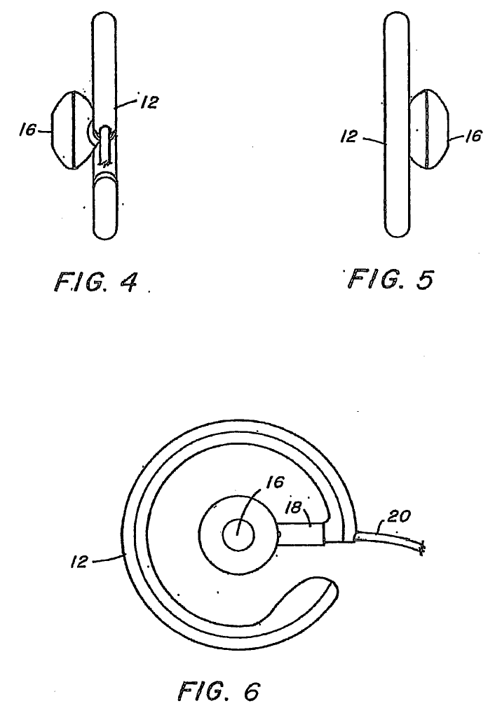

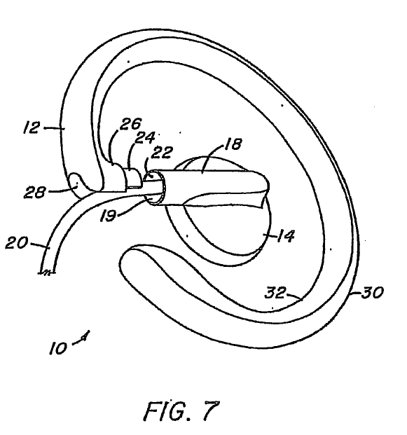

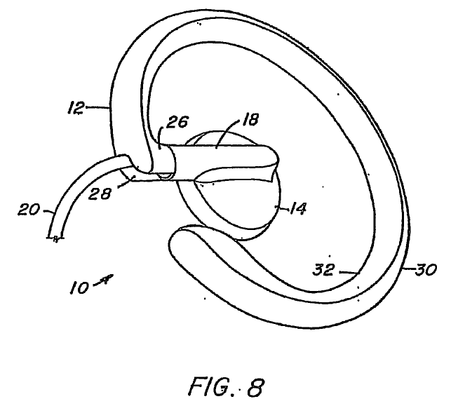

Earbud 14 includes a speaker housing 16 (FIGS. 4 and 6) and a stem portion 18 (FIG. 6). A speaker (not shown) is disposed in the speaker housing 16 and the speaker housing 16 is generally shaped to fit up against the ear and rest at the external portion of the ear canal. The speaker housing may include a soft cover for the user's comfort. A wire 20 (FIG. 6) for carrying electrical signals to the speaker is connected through the stem portion 18 via an opening 19 (FIG. 7) of stem portion 18 to an internal speaker (not shown) of earbud 14. Stem portion 18 also includes a hollow tubular portion 22.

Earhook 12 includes an extension portion 24 at its end 26 (FIG. 7) for engagement via opening 19 with stem portion 18 of the earbud 14. Earhook 12 also includes a recessed, open-sided passage 28 to removably receive wire 20. Passage 28 is configured to provide a streamlined profile when earhook 12 is connected to the earbud 14.

In FIG. 7, the earhook and earbud headset 10 is illustrated with the earhook 12 disconnected from the earbud 14 and wire 20 only partially within passage 28. Earhook 12 may be detachably, i.e., removably, attached to earbud 14 by inserting the extension portion 24 of the earhook 12 into the hollow, tubular portion 22 of earbud 14. Earhook 12 may be connected to earbud 14 by means of a frictional fit to retain earbud 14 on earhook 12 when headset 10 is in use, while readily permitting disengagement of earbud 14 from earhook 12 when desired. In a preferred embodiment, earhook 12 is connected to earbud 14 by means of a snap fit which serves to attach the earbud 14 to the earhook 12 with higher retention strength than a frictional fit, but nonetheless still enabling the user to readily disconnect earhook 12 from earbud 14 if it is desired to use the earbud 14 without the earhook 12. A “snap fit” means that a deformable, resilient structure such as a flexible lip is formed on or within one or both of extension portion 24 and tubular portion 22 so that a certain degree of force is required to temporarily deform the resilient structure both to connect and disconnect earbud 14 and earhook 12.

Whether a frictional or snap fit is employed, the earbud 14 may be rotated relative to the earhook 12 about extension portion 24, i.e., about axis of rotation R-R (FIG. 1). The extension portion 24 of the earhook 12 and the hollow tubular portion 22 of earbud 14 are configured to be rotatable relative to each other, e.g., by being circular or, in the case of extension portion 24, semi-circular, in cross section. Extension portion 24 and hollow tubular portion 22 are also configured to provide a friction fit tight enough to hold earbud 14 in place in any selected rotational angular orientation relative to earhook 12. Any other suitable arrangement, such as interlocking serrations or a ratchet-like construction, may be used to enable earbud 14 to be rotated to and retained in a desired angular orientation. By a 180-degree rotation of earbud 14 about extension portion 24, earbud 14 can be rotated from the position shown in solid lines in FIGS. 4 and 5, to the position shown in phantom outline in FIGS. 4 and 5. This rotation permits selectively positioning earbud 14 to adjust the angle of the earbud 14 to the earhook 12 for a more comfortable fit or, by a rotation of, for example, about 180 degrees, to enable headset 10 to be worn on either the left or right ear of the user, and/or to be worn as one of a pair of such headsets, one on each ear. FIG. 4 shows a plane P-P within which earhook 12 lies. Rotation of earbud 14 between the positions shown, respectively, in solid line and phantom outline, is rotation “transversely through the plane in which the earhook lies”, as the quoted term is used in the claims. Such rotation can be used to position the speaker housing 16 at the external portion of the user's ear canal whether headset 10 is worn on either the left or right ear of the user. A lesser degree of rotation may of course be employed for comfort and fit adjustments. In some cases, the configuration of extension portion 24 and tubular portion 22 is selected to limit the available degree of rotation. This simplifies the design and a limited freedom of rotation, e.g., about 20 degrees toward the front of the user's head, has been found ample to provide fit and comfort adjustments.

With reference to FIG. 8, headset 10 is illustrated with the earhook 12 connected to the earbud 14. End 26 of earhook 12 is preferably seated flush against stem 18 of earbud 14. Earbud 14 may rotate, as described above, with respect to earhook 12. Wire 20 is positioned in passage 28 when earhook 12 is connected to earbud 14. Preferably, wire 20 is dimensioned to provide a friction-fit when received in passage 28, to insure that wire 20 is securely retained within passage 28 and thus constrained to lie behind the user's ear. In this manner, the direction of wire 20 is better managed for comfort and ease of use.

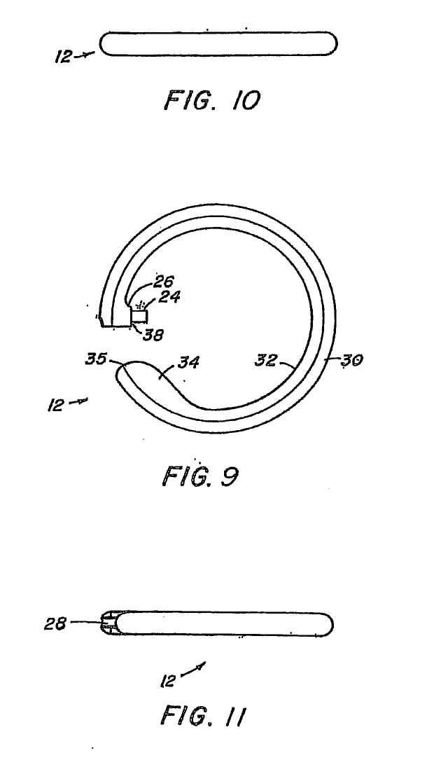

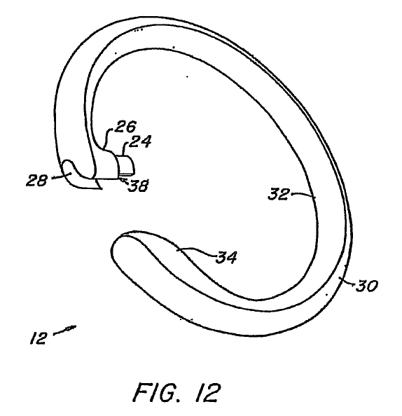

Turning now to FIGS. 9 through 12, earhook 12 is seen to comprise a substantially circular, interrupted ring having an outer case 30 and an inner surface 32, each forming approximately ninety percent of a complete circle. Preferably, outer case 30 is constructed of plastic and inner surface 32 is constructed of a soft material, preferably a soft elastomer such silicone, Toshiba TSE 260 7U. Earhook 12 is flexible and resilient to allow temporary distortion of it in order to facilitate placement of earhook 12 around the ear. Earhook 12 includes an enlarged region 34 at end 35 for added comfort and fit. The enlarged region 34 may include a plurality of ribs (not shown) for additional comfort and fit. (Such ribs would be comparable to ribs 50 of the embodiment of FIG. 16.) End 26 (FIGS. 9 and 12) includes a surface 38 that sits adjacent stem portion 18 (FIG. 8) of the earbud 14 when the earhook 12 is attached to the earbud 14.

Extension portion 24 is configured to form a semi-cylinder to allow earbud 14 to rotate with respect to earhook 12. In this way, the earbud 14 may be rotated to a selected position, including rotation from one side of the earhook 12 to the other, so that the headset 10 may be worn on either the wearer's right ear or the wearer's left ear. Earbud 14 may also be rotated a smaller angle in order to provide a customized, more comfortable fit for a particular user.

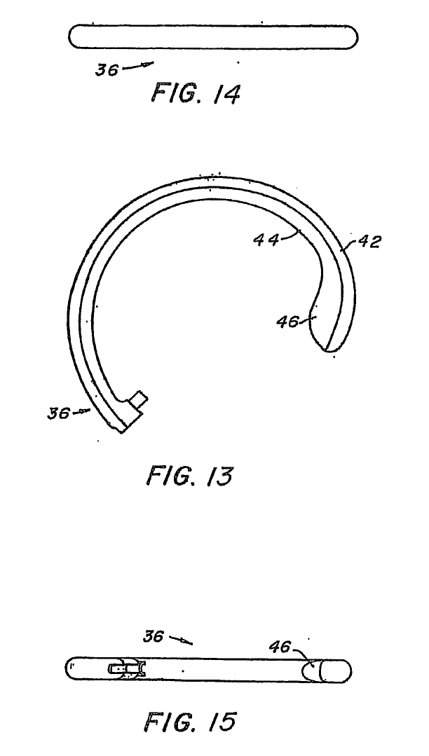

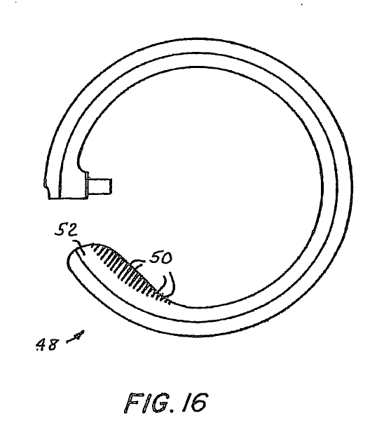

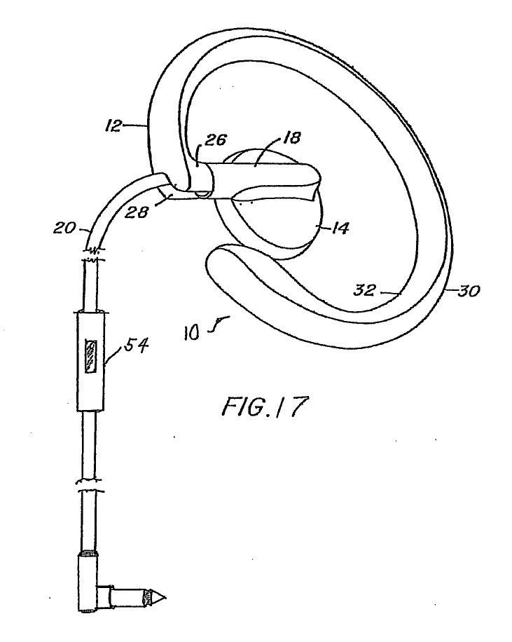

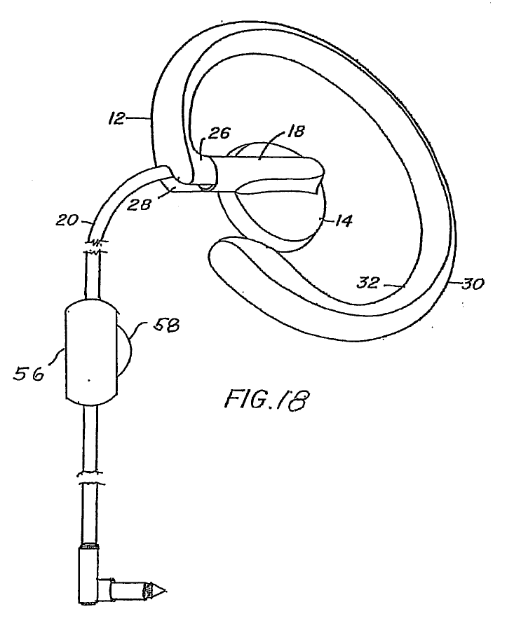

Turning now to FIGS. 13 through 15, another embodiment of an earhook is illustrated. Earhook 36 comprises an interrupted circular ring having an outer case 42 and an inner surface 44 forming approximately sixty percent of a compete circle. An enlarged region 46 is also provided as is an open-sided passage 28. Earhook 36 is connected to the earbud 14 at extension portion 24′ in a similar manner to that of earhook 12.

As shown in FIG. 16, another embodiment of an earhook is shown. Earhook 48 has an enlarged region 52 which may comprise a cushioned region made of softer material than other parts of the earhook. Enlarged region 52 may include a plurality of ribs 50 for the additional comfort of the user.

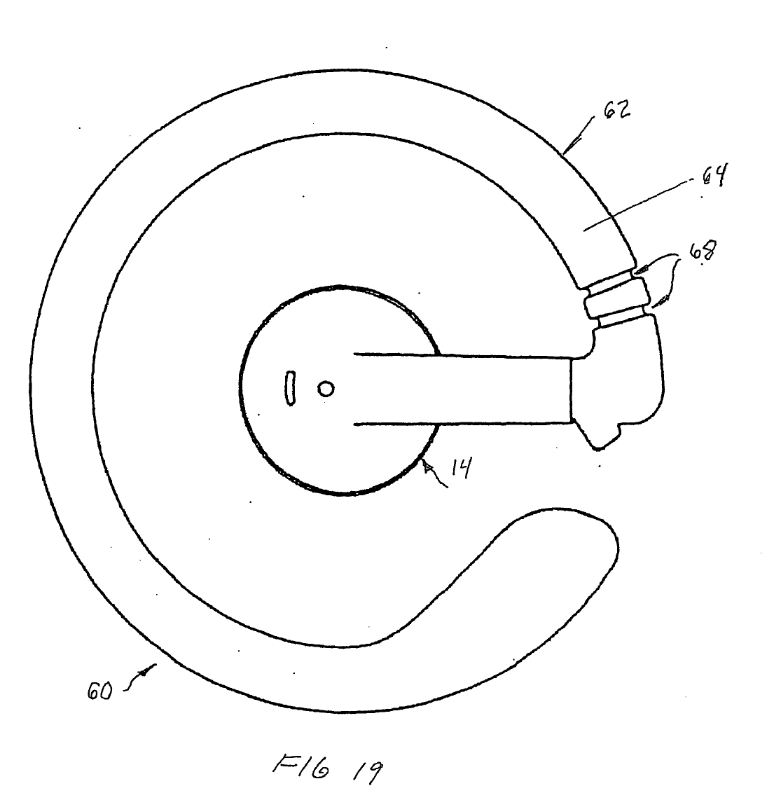

In another aspect of the invention, headset 10 may be used in telecommunications. For example, as shown in FIG. 17, earhook 12 and earbud 14 may be used in combination with a microphone 54 for use in telecommunication applications. In such a configuration, headset 10 may be configured as a pair of earhooks 12 and earbuds 14 and worn on both ears or as a single unit worn on one ear.

As shown in FIG. 18, earhook 12 and earbud 14 may be connected to a control unit 56. Control unit 56 includes volume switch 58 and may also include a microphone and/or stereo controls for the convenience of the user in stereo listening and/or telecommunications. In such a configuration, headset 10 may be configured as a pair of earhooks 12 and earbuds 14 and worn on both ears or as a single unit worn on one ear.

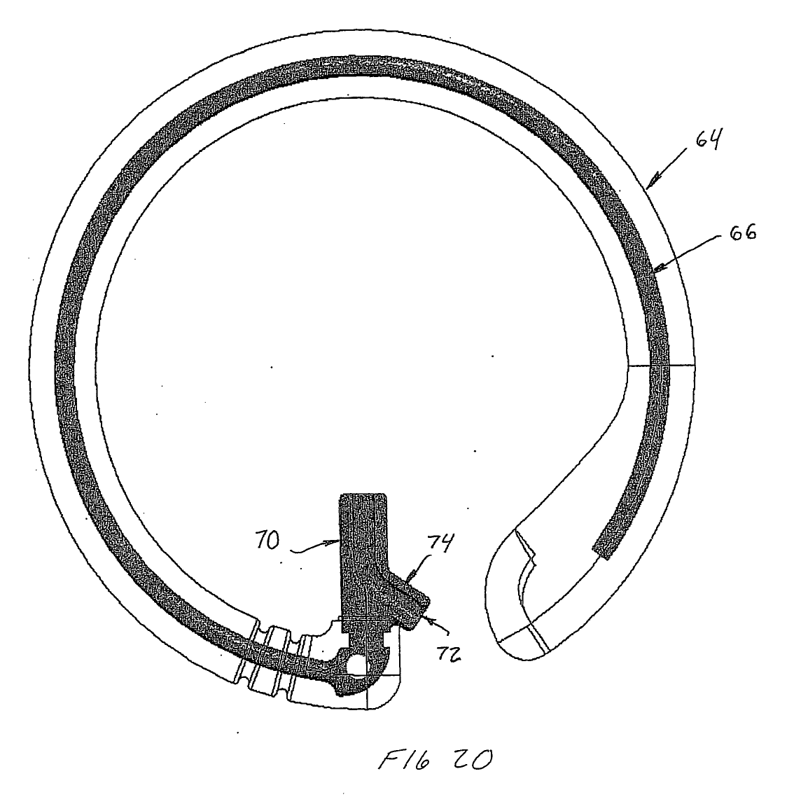

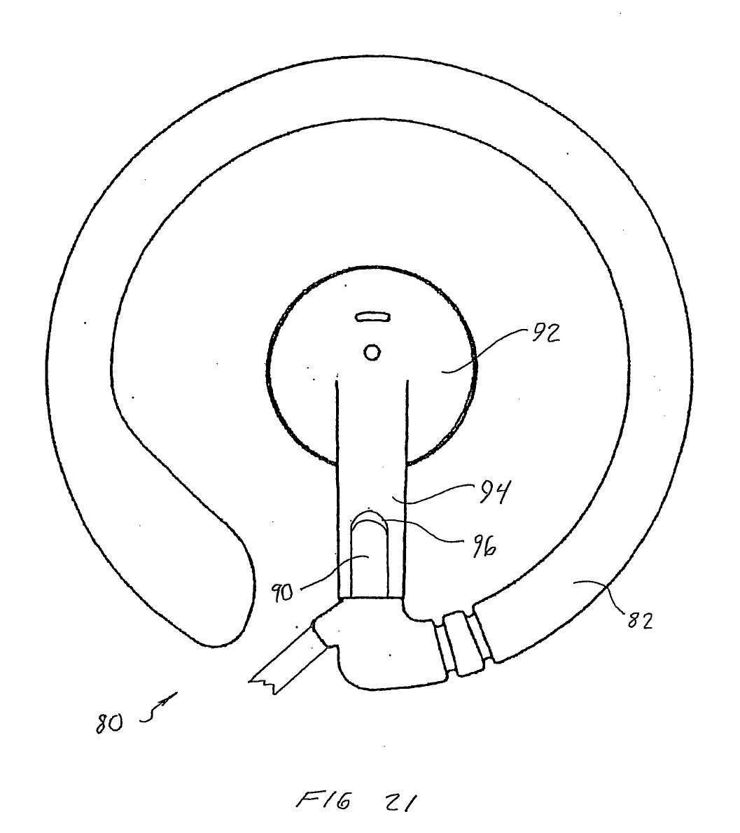

As shown in FIGS. 19 and 20, another embodiment of the invention is shown at 60. Earhook 62 includes an outer ring 64 which surrounds an inner support 66 (shown in FIG. 20). The outer ring 64 is made of a soft elastomer, preferably silicone, Toshiba TSE 260 7U having a shore A durometer of approximately 70. The inner support 66 is preferable made of plastic. Earhook 62 includes strain reliefs 68 for additional flexibility and comfort. Inner support 66 comprises a post 70 for pivotally mounting earbud 14. Post 70 includes a channel 72 for chord management. Preferably post 70 includes an extension 74 through which chord passes in channel 72.

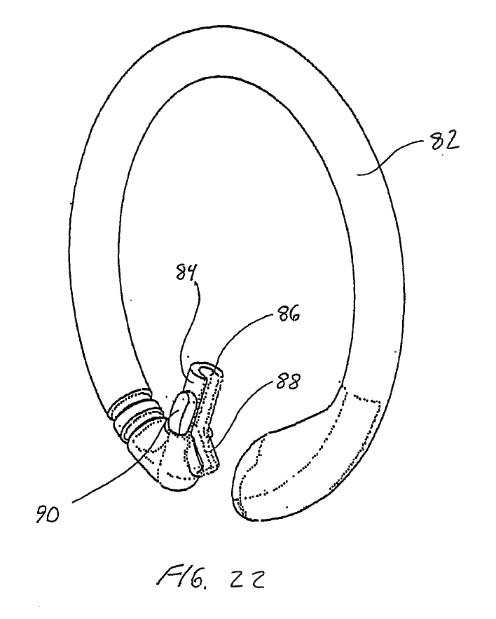

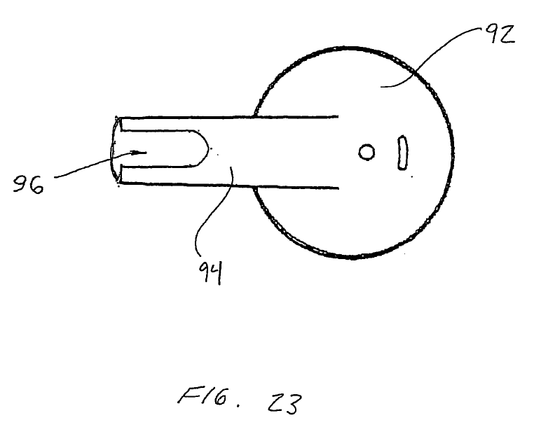

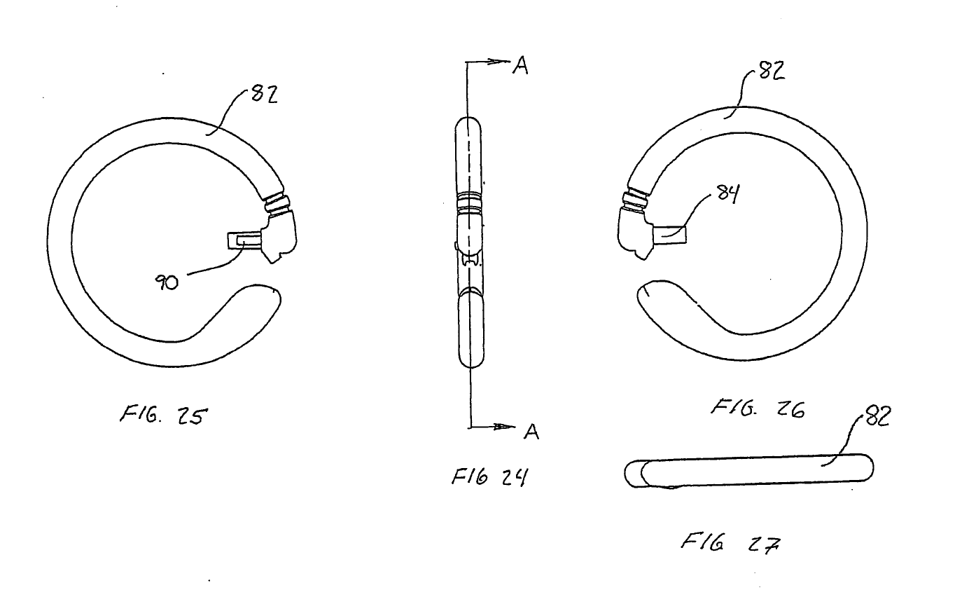

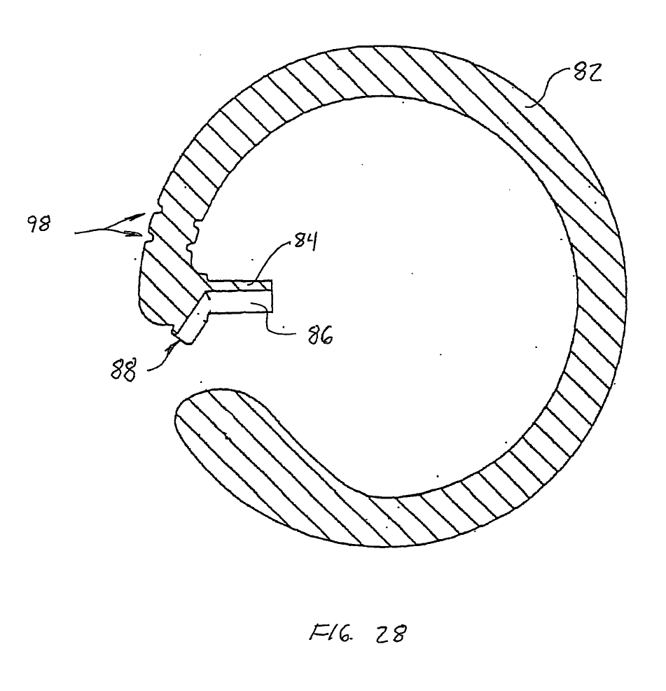

As shown in FIGS. 21 through 28, another embodiment of the invention is shown at 80. Earhook 82 comprises a soft elastomer, such as silicone, Toshiba TSE 260 7U. Ear hook 82 includes a post portion 84 having a channel 86 for chord management. The post portion 84 includes an angled extension 88. Channel 86 is coextensive with post portion 84 and angled extension 88. Post portion 84 includes a protuberance 90. Turning to FIG. 23, earbud 92 includes stem portion 94 having an opening in the form of a slot 96. For removable attachment of earbud 92 to earhook 82, post portion 84 is received within stem portion 94 of earbud 92 such that the protuberance 90 of earhook 82 is received within slot 96. Protuberance 90 is constructed of a soft elastomer, such as silicone, Toshiba TSE 260 7U, and deforms slightly when received in slot 96 to assist with the removable attachment of earbud 92 to earhook 82.

As shown in FIG. 28, earhook 82 may be molded as a unitary piece of a soft elastomer, such as silicone, Toshiba TSE 260 7U, having a shore A durometer of approximately 70. Earhook 82 includes strain reliefs 98 for additional flexibility and comfort.

While the invention has been described with reference to a preferred embodiment, it will be understood by those skilled in the art that various changes may be made and equivalents may be substituted for elements thereof without departing from the scope of the invention. In addition, many modifications may be made to adapt the invention to a particular situation or material to the teachings of the invention without departing from the essential scope thereof. Therefore, it is intended that the invention not be limited to the particular embodiment disclosed, but that the invention will include all embodiments falling within the scope of the appended claims.

What is claimed is:

1. A headset comprising:
an earbud having a speaker and a stem, and an earhook having an inlet end, the stem and the inlet end being configured to enable removable coupling of the earbud and earhook to each other.

2. The headset of claim 1 wherein the stem has an opening at one end and the earhook has an inlet end configured to be at least partly received within the opening to effectuate the removable coupling of the earbud and earhook to each other.

3. The headset of claim 1 wherein the earhook includes a protuberance and the stem includes a slot, said protuberance being removably received in said slot.

4. The headset of claim 1 wherein the earhook lies in a plane and the earbud is mounted on the earhook for rotation to a selected angle relative to the plane in which the earhook lies.

5. A headset comprising:
an earbud having a speaker and a stem and an earhook which lies in a plane and has an inlet end, the stem and inlet end being configured to permit rotation of the earbud to a selected angle relative to the plane in which the earhook lies.

6. The headset of claim 1 or claim 5 wherein the earbud is mounted for rotation transversely through the plane in which the earhook lies, from one side of the earhook to the other.

7. The headset of claim 6 wherein the earbud is mounted for rotation of at least about 180 degrees.

8. The headset of claim 6 wherein the stem has an opening at one end and the earhook has an inlet end configured to be at least partly received within the opening, and the inlet end and the opening of the stem are each configured to be rotatable relative to each other.

9. The headset of claim 1 or claim 5 wherein the stem comprises an elongated portion of the housing having an opening at one end; and
the inlet end of the earhook is configured to be received within the opening at one end of the housing.

10. The headset of claim 1 or claim 5 wherein the headset further comprises a microphone.

11. A headset comprising:
an earbud having a speaker and a stem, the stem having an opening at one end;
a conductor connected to the speaker for communicating electrical signals thereto, the conductor passing through the opening; and
an earhook having an inlet end configured to be at least partly received within the opening of the stem, the earhook and the stem being removably coupled to each other.

12. The headset of claim 11 wherein the earhook further comprises an open-sided inlet passage to removably receive the conductor.

13. The earhook of claim 12 wherein the open-sided inlet passage is located in the inlet end of the earhook.

14. The headset of claim 11 wherein the inlet end of the earhook is comprised of an extending portion to be received in the opening of the stem, and an inlet portion through which the inlet passage extends.

15. The headset of claim 11 wherein the stem and the earhook are removably coupled by a snap fit.

16. The headset of claim 11 wherein the earhook lies in a plane and the earbud is mounted on the earhook for rotation of at least 180 degrees transversely through the plane in which the earhook lies, from one side of the earhook to the other.

17. The headset of claim 11 wherein the earhook is configured as an interrupted ring shape.

18. The headset of claim 11 wherein the earhook comprises an inner surface having an elastomer disposed thereon.

19. The headset of claim 18 wherein the elastomer has a shore A durometer of less than about 70.
